(19) United States
(12) Patent Application Publication
(10) Pub. No.: US 2019/0184280 A1
(43) Pub. Date: Jun. 20, 2019

(54) REAL WORLD GAMING

(71) Applicant: Alan Jones, Alexandria, KY (US)

(72) Inventor: Alan Jones, Alexandria, KY (US)

(21) Appl. No.: 15/849,051

(22) Filed: Dec. 20, 2017

(51) Int. Cl. A63F 13/219; A63F 13/213; A63F 13/25; A63F 13/215

(52) U.S. Cl. CPC A63F 13/219; A63F 13/213; A63F 2300/8082; A63F 13/215; A63F 2300/8076; A63F 13/25

(57) ABSTRACT

The present invention is a real world gaming system having a main unit controller connected to a gun controller; a headset connected to the main unit controller, the headset has a camera in front of speakers the speakers near a user's ears and a microphone positioned to the users mouth. The real world gaming headset has a 180 degree view.

### BACKGROUND OF THE INVENTION

### Field of the Invention

The present invention is in the field of video gaming. More specifically, the present invention is a first-person shooter game played through a virtual reality headset.

### Description of the Related Art

The present invention is a first-person shooter game played through a virtual reality headset called real world gaming. Virtual reality is the computer-generated simulation of a three-dimensional image or environment that individuals can interact with in a seemingly real way by using specific electronic equipment. Currently, there are limited options of virtual reality equipment or games created uniquely for them, as it is a fairly new technology. Ingenious and practical, real world gaming introduces a first-person shooter game that is played through virtual reality, granting consumers a new thrilling gaming experience. Simple to use, individuals may wear the slim glasses integrated with a camera to have a 180-degree view of a virtual setting display accompanied by sounds heard through speakers. Once worn, players will have to simulate the movements they wish to make in game as they combat enemies that appear on top or behind everyday surroundings. Players will have to utilize their gun controller to defend themselves against other real players or computer generated targets, which vibrates upon one being hit or shot, similarly as current game controllers do, effectively alerting players of character damage and adding a shock factor to the simulation experience. Real world gaming can easily become an essential alternative to traditional first-person shooter games, making it possible to be readily available at electronic stores and/or online retailers.

Real world gaming is the only product of its kind to provide a virtual reality first-person shooter game. Real world gaming is uniquely designed to grant internet access to users, permitting one to surf the web by navigating a touchpad mouse; ultimately, expanding its functionality as an entertainment accessory.

### BRIEF DESCRIPTION OF THE DRAWINGS

The present invention will be described by way of exemplary embodiments, but not limitations, illustrated in the accompanying drawings in which like references denote similar elements, and in which:

FIG. 1 illustrates a real world gaming system, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention, however the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

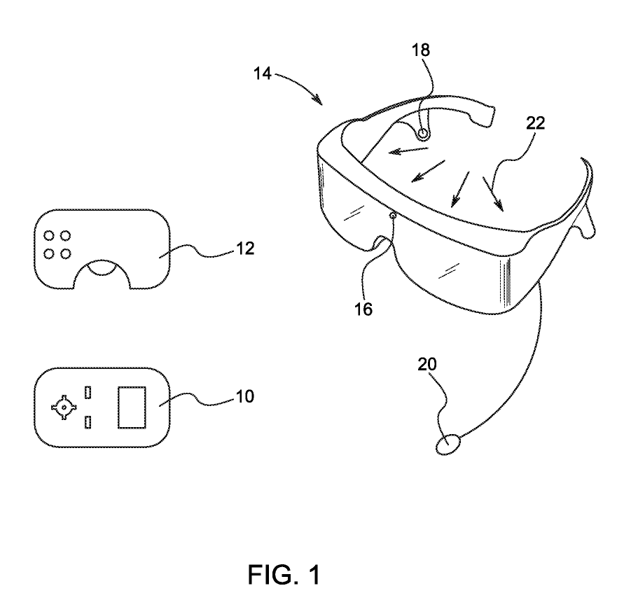

Referring now to FIG. 1, illustrated is a real world gaming system, in accordance with one embodiment of the present invention. In FIG. 1, illustrated is a main unit controller 10 and a gun controller 12. Headset 14 is shown with a camera 16 in front of speakers 18 to be placed for a user's ears and a microphone 20 positioned to the users mouth. Headset 14 has a 180 degree view 22.

While the present invention has been related in terms of the foregoing embodiments those skilled in the art will recognize that the invention is not limited to the embodiments described. The present invention may be practiced with modification and alteration within the spirit and scope of the appended claims. Thus, the description is to be regarded as illustrative instead of restrictive on the present invention.

1. A real world gaming system comprising:
a main unit controller connected to a gun controller, such that the gun controller has a semicircular recess disposed on at least one side of the gun controller, such that a semicircular protrusion is disposed within the semicircular recess;
a headset connected to the main unit controller, the headset has a camera in front of speakers the speakers adapted to be placed near a user's ears and a microphone adapted to be positioned to the users mouth.

2. The real world gaming system according to claim 1, wherein the headset has a 180 degree view.

3. A real world gaming system to simulate a player in a virtual reality game, the real world gaming system comprising:
a main unit controller to move the player in the virtual reality game, the main unit controller comprising:
a body having a plurality of curved corner portions, and
a rectangular portion disposed on at least a portion of a surface of the body;
a gun controller to defend the player against another player in the virtual reality game, the gun controller comprising:
a body, and
a vibration unit disposed within at least a portion of the body to vibrate in response to the player being hit in the virtual reality game; and
a headset to display the simulation of the virtual reality game, the headset comprising:
a camera disposed on a front side of the headset to receive images from surroundings of the player,
a plurality of speakers disposed on a rear portion of the headset to emit sounds from the virtual reality game, and
a microphone disposed on the front side of the headset to receive speech from the player.
